(19) United States
(12) Patent Application Publication
(10) Pub. No.: US 2007/0252794 A1
(43) Pub. Date: Nov. 1, 2007

(54) Image display apparatus

(75) Inventors: Hong-seok Lee, Seongnam-si (KR); Su-mi Lee, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/546,311

(22) Filed: Oct. 12, 2006

(30) Foreign Application Priority Data
Apr. 28, 2006 (KR) 10-2006-0038878

(51) Int. Cl. G09G 3/36

(52) U.S. Cl. 345/87

(57) ABSTRACT

Provided is an image display apparatus including: a screen, on which a plurality of pixels operating in a diffusion mode and a transmission mode are arranged; a light source unit which irradiates a plurality of single color lights sequentially onto the screen; and a driving unit which converts the operating mode of the plurality of pixels into one of the diffusion mode and the transmission mode according to image data, wherein the colors of the image data are separated in synchronization with the plurality of single color lights.

### CROSS-REFERENCE TO RELATED PATENT APPLICATIONS

This application claims priority from Korean Patent Application No. 10-2006-0038878, filed on Apr. 28, 2006, in the Korean Intellectual Property Office, the disclosure of which is incorporated herein in its entirety by reference.

### BACKGROUND OF THE INVENTION

1. Field of the Invention

The present invention relates to an image display apparatus, and more particularly, to an image display apparatus that can display full-color images.

2. Description of the Related Art

Recently, flat panel displays (FPDs) using liquid crystal panels or plasma panels, and projection image display apparatuses are being widely used instead of conventional image display apparatuses using a cathode ray tube (CRT). The FPDs adopt color filters in order to display color images. In this case, a pixel of a panel should be divided into three color pixels, that is, red, green, and blue pixels, and thus, it is difficult to improve resolution. In addition, when light of a certain color component is used to display images among the light incident onto the panel, the brightness of the image display apparatus is lowered.

Projection image display apparatuses are apparatuses modulating a light corresponding to an aspect ratio of an image to be displayed according to image information, and projecting the modulated light onto a screen. The projection image display apparatus should include a high-functional optical device in order to adjust the aspect ratio of the light and project the modulated light onto the screen.

### SUMMARY OF THE INVENTION

The present invention provides an image display apparatus displaying color images using a simple structure.

According to an aspect of the present invention, there is provided an image display apparatus including: a screen, wherein a plurality of pixels operating in one of a diffusion mode and a transmission mode are arranged on the screen; a light source unit which irradiates a plurality of single color lights sequentially onto the screen; and a driving unit which converts the operating mode of the plurality of pixels into one of the diffusion mode and the transmission mode according to image data, wherein colors of the image data are separated, in synchronization with the plurality of single color lights.

The plurality of pixels may include a liquid crystal layer formed of polymer dispersed liquid crystal (PDLC) or polymer networked liquid crystal (PNLC), and a transparent electrode for applying a voltage to the liquid crystal layer.

According to another aspect of the present invention, there is provided an image display apparatus for displaying a color image, the apparatus including: a reflective liquid crystal panel; a light source unit which irradiates a plurality of single color lights sequentially onto a surface of the reflective liquid crystal panel; and a driving unit which drives the reflective liquid crystal panel according to image data, wherein the colors of the image data are separated in synchronization with the plurality of single color lights.

The image display apparatus may further include: a body supporting the reflective liquid crystal panel, and the light source unit moves between a first position wherein the light source unit is folded upon the body, and a second position wherein the light source unit is raised for irradiating the light onto the reflective liquid crystal panel. The reflective liquid crystal panel may include a liquid crystal layer formed of polymer dispersed liquid crystal (PDLC) or polymer networked liquid crystal (PNLC), and a transparent electrode for applying a voltage to the liquid crystal layer. The driving unit may include a gradation driver controlling a magnitude of the voltage applied to the transparent electrode corresponding to the gradation of the image data.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an image display apparatus according to an exemplary embodiment of the present invention;

FIG. 2 is a cross-sectional view of a screen of FIG. 1;

FIG. 3 is a cross-sectional view of the screen for illustrating a diffusion mode of the screen;

FIG. 4 is a cross-sectional view of the screen for illustrating a transmission mode of the screen;

FIG. 5 is a block diagram of an image display apparatus including a cylindrical screen according to another exemplary embodiment of the present invention;

FIG. 6 is a perspective view of the image display apparatus according to the exemplary embodiment of the present invention applied to a reflective liquid crystal display apparatus;

FIG. 7 is a perspective view of an image display apparatus according to another exemplary embodiment of the present invention applied to the reflective liquid crystal display apparatus;

FIG. 8 is a perspective view of a portable status of the image display apparatus of FIG. 7;

FIG. 9 is a perspective view of an image display apparatus according to another exemplary embodiment of the present invention applied to the reflective liquid crystal display apparatus; and

FIG. 10 is a perspective view of a portable status of the image display apparatus of FIG. 9.

### DETAILED DESCRIPTION OF THE EXEMPLARY EMBODIMENTS

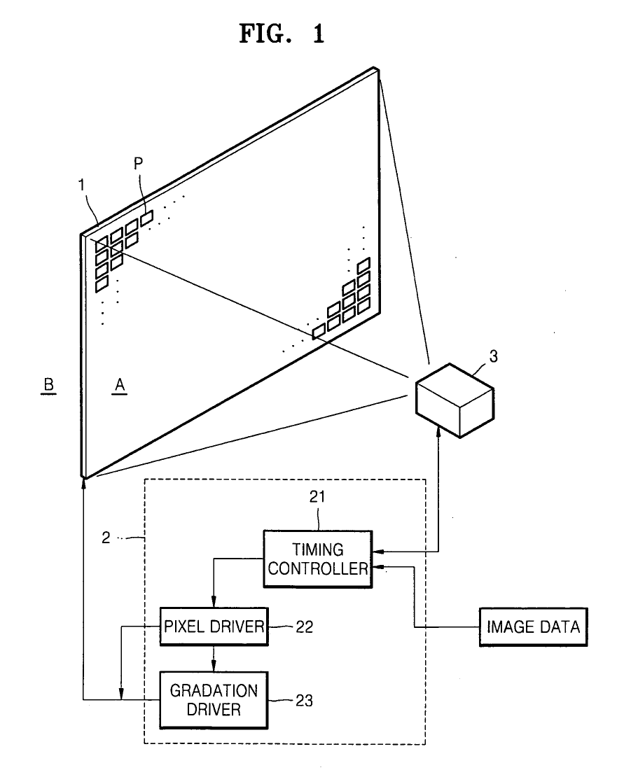

FIG. 1 is a block diagram of an image display apparatus according to an exemplary embodiment of the present invention. Referring to FIG. 1, the image display apparatus according to the present exemplary embodiment includes a screen 1, a light source unit 3, and a driving unit 2. A plurality of pixels (P) are arranged on the screen 1 as a matrix. The plurality of pixels P operate in two modes, that is, a diffusion mode for diffusing light and a transmission mode for transmitting the light.

Polymer dispersed liquid crystal (PDLC) or polymer networked liquid crystal (PNLC) can be used to form the pixels P. Hereinafter, the pixels P formed using the PDLC will be described.

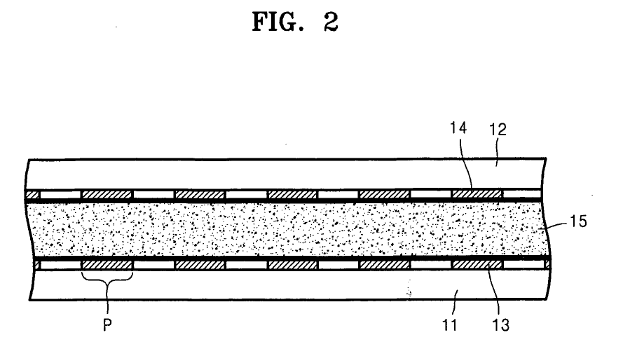

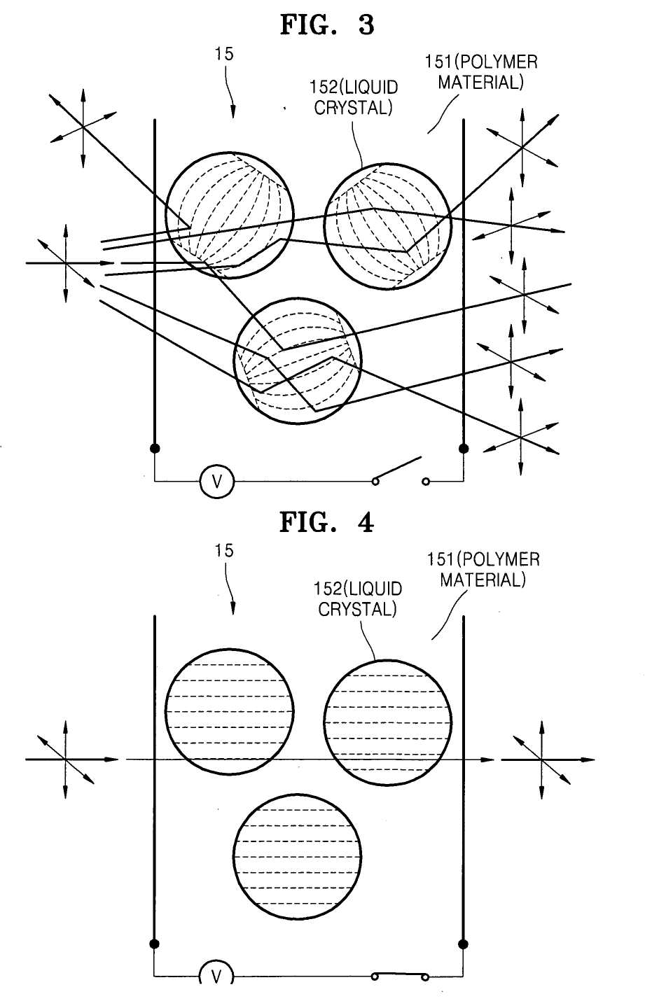

FIG. 2 is a cross-sectional view of the screen 1. Referring to FIG. 2, a liquid crystal layer 15 is sealed between transparent substrates 11 and 12. The transparent substrates 11 and 12 respectively include transparent electrodes 13 and 14 for applying voltages to the liquid crystal layer 15. Referring to FIGS. 3 and 4, the liquid crystal layer 15 is formed by dispersing liquid crystals 152 in polymer 151. As shown in FIG. 3, refractive indexes of the liquid crystal 152 and the polymer material 151 are not the same as each other in a case where the voltage is not applied to the transparent electrodes 13 and 14. Consequently, reflection and refraction occur at boundaries of the liquid crystal 152 and the polymer material 151. Therefore, the light incident into the liquid crystal 15 is diffused. Then, all of the pixels P have a milky state. When the voltage is applied to the transparent electrodes 13 and 14, the liquid crystals 152 are arranged in a direction of the electric field as shown in FIG. 4. In this status, since the refractive indexes of the polymer material 151 and the liquid crystal 152 are equal to each other, the light transmits the liquid crystal layer 15. As described above, when the electric field is selectively generated in the liquid crystal layer 15, the pixels P can operate in the diffusion mode (FIG. 3) or in the transmission mode (FIG. 4). Although it is not shown in the drawings, protective films can be further disposed on outer portions of the transparent substrates 11 and 12.

The light source unit 3 irradiates a plurality of single color lights, for example, red, green, and blue lights, sequentially onto the screen 1. Although it is not shown in the drawings, the light source unit 3 may include three lamps respectively irradiating the red, green, and blue lights. In addition, the light source unit 3 may include a light source irradiating white light, and a color filter transmitting the red, green, and blue lights. For example, a color filter transmitting the red, green, and blue lights is installed on a rotation plate, and then, the rotation plate rotates to sequentially irradiate the red, green, and blue lights.

The driving unit 2 converts the operating mode of the plurality of pixels P into the diffusion mode or the transmission mode selectively according to image data, the color of which is separated to correspond to the plurality of single color lights. The driving unit 2 includes a timing controller 21 for synchronizing the color-separated image data with the light source unit 3, and a pixel driver 22 for applying voltages to the plurality of pixels P. The driving unit 2 may further include a gradation driver 23. A scattering coefficient of the liquid crystal layer 15 is dependent on a magnitude of the voltage applied to the liquid crystal layer 15. The gradation driver 23 controls the magnitude of the voltage applied to the transparent electrodes 13 and 14 for representing the gradation of the image.

Exemplary operations and effects of the above structure will now be described.

The image data is separated by colors corresponding to the red, green, and blue colors. The timing controller 21 synchronizes the red, green, and blue image data with the red, green, and blue light emitting times of the light source unit 3. For example, in order to display a red image, the pixel driver 22 controls the pixels P to be in the diffusion mode when the red light is irradiated from the light source unit 3. The red light is reflected by the pixels P, and the reflected light displays the red image on a front side A (refer to FIG. 1) of the screen 1. Intermediate colors can be represented by mixing the red, green, and blue lights. In addition, the gradation can be represented by controlling the voltage applied to the liquid crystal layer 15 using the gradation driver 23. As described above, the operating mode of the plurality of pixels P is selectively changed to the diffusion mode and the transmission mode according to the color-separated image data in synchronization with the on and off timings of the plurality of single color lights that are irradiated from the light source unit 3.

In the above description, the case where the image is displayed on the front side A of the screen 1 is described. However, the image can be displayed on a rear side B of the screen 1 by converting the operating mode of the pixels P into the transmission mode with respect to the color to be displayed.

The above image display apparatus has the following advantages.

Since the light source unit 3 simply irradiates the plurality of single color lights sequentially, it does not need to focus on the screen 1 accurately. There is no need to coincide the aspect ratio of the irradiated light with the aspect ratio of the displayed image. Therefore, a structure of the optical system can be very simple.

When the image is not displayed, the plurality of pixels P operate in the diffusion mode to make the screen 1 opaque, or the plurality of pixels P operate in the transmission mode to make the screen 1 transparent. Some of the plural pixels P may operate to display the image on a desired portion of the screen 1, and the other pixels P operate in the diffusion mode or the transmission mode to make the other portions of the screen 1 opaque or transparent. In addition, the image can be selectively displayed on the front side A or the rear side B of the screen 1.

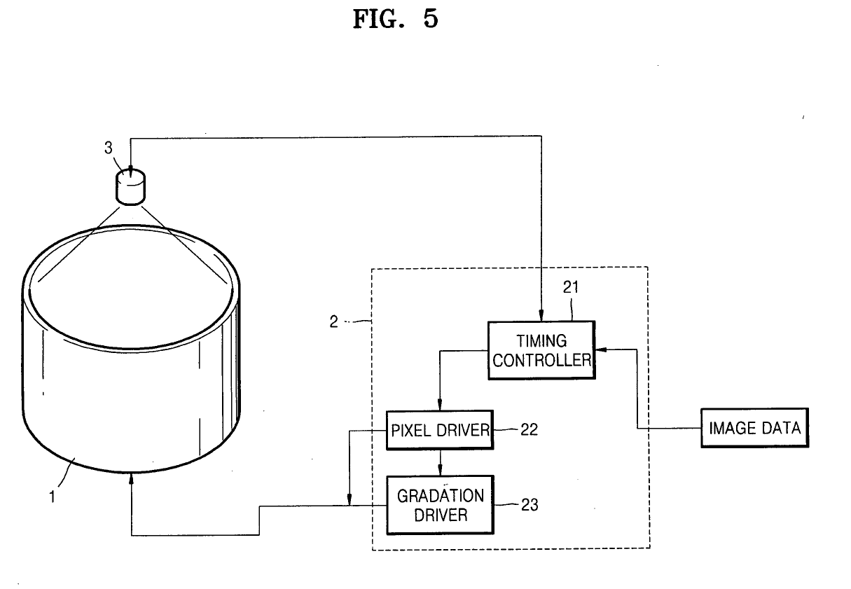

The image can be selectively displayed on the sides A and B of the screen 1 using the diffusion mode or the transmission mode. In particular, if the image is displayed using the diffusion mode, a wide viewing angle can be ensured even when the screen 1 is tilted. In addition, as shown in FIG. 5, the screen 1 can be formed as a cylinder, and the light source unit 3 is installed on the center portion of the cylindrical screen 1 to display the image on an outer portion or an inner portion of the screen 1. The image display apparatus having the above structure cannot be realized by using the general projector that irradiates the light that is modulated according to the image information onto the screen.

The above image display apparatus according to an exemplary embodiment of the present invention can be used as a public information display (PID) effectively. Further, the above image display apparatus can be applied to a reflective liquid crystal display apparatus.

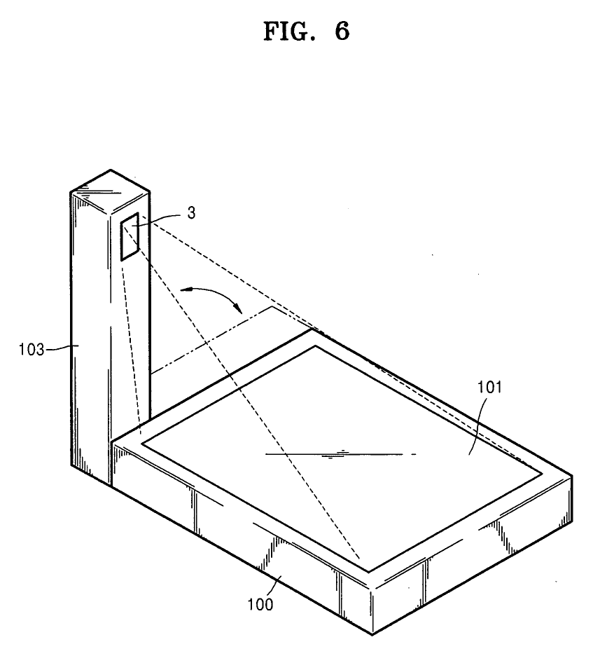

Referring to FIG. 6, a reflective liquid crystal panel 101 is installed on a body 100. A cross-section of the reflective liquid crystal panel 101 is the same as that of FIG. 2. The reflective liquid crystal panel 101 can be formed of polymer dispersed liquid crystal (PDLC) or polymer networked liquid crystal (PNLC). Although it is not shown in the drawings, the driving unit 2 shown in FIG. 1 is installed in the body 100. The light source unit 3 simply irradiates the plurality of single color lights onto the surface of the reflective liquid crystal panel 101. The light source unit 3 is installed on an arm 103 that is supported by the body 100 to be rotatable. When the arm 103 rotates, the light source unit 3 moves between a first position denoted by chain double-dashed lines where the light source unit 3 is folded onto the body 100 and a second position denoted by a solid line where the light source unit 3 is raised and stands up for lighting the reflective liquid crystal panel 101. According to the above structure, the operating mode of the plurality of pixels P on the reflective liquid crystal panel 101 is selectively changed into the diffusion mode or the transmission mode according to the color separated image data in synchronization with the on and off timings of the plurality of single color lights that are irradiated from the light source unit 3, and thus, the color image can be displayed. In this case, the image is displayed by the light reflected from the reflective liquid crystal panel 101 using the diffusion mode.

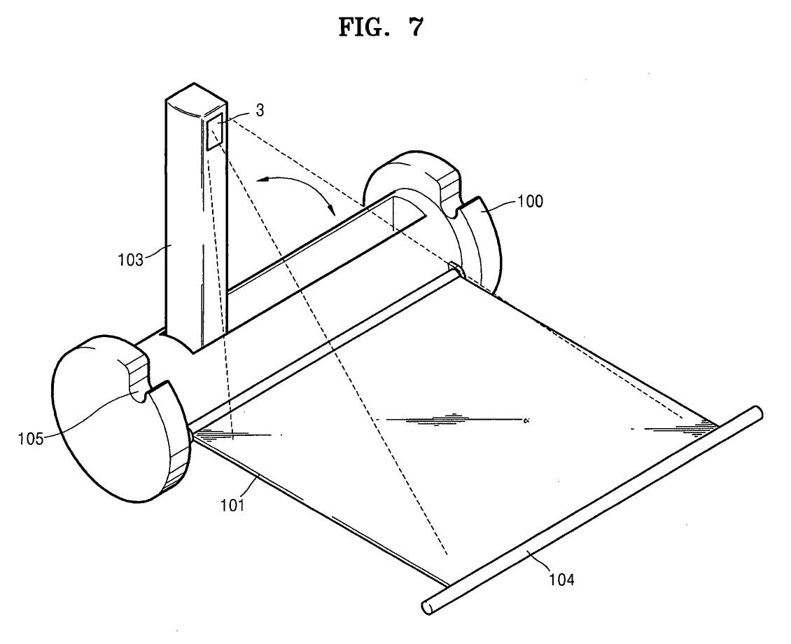

Referring to FIG. 7, the reflective liquid crystal panel 101 can be fabricated as a sheet type. An end portion of the reflective liquid crystal panel 101 is supported by the body 100. In addition, a supporting member 104 for supporting the reflective liquid crystal panel 101 to be flat is disposed on the other end portion of the reflective liquid crystal panel 101. The reflective liquid crystal panel 101 may be coupled to body 100 and the supporting member 104 to be rotatable.

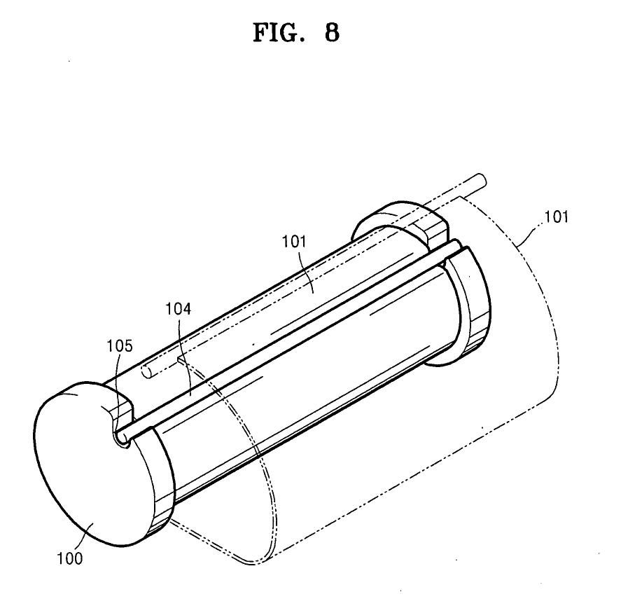

When the image is displayed, the reflective liquid crystal panel 101 is spread as shown in FIG. 7, and then the arm 103 is raised to irradiate the light onto the reflective liquid crystal panel 101 using the light source unit 3. When the image display apparatus is carried, as shown in FIG. 8, the arm 103 is folded and the reflective liquid crystal panel 101 is rolled up based on the body 100. Reference numeral 105 denotes an insertion hole, into which the end portion of the supporting member 104 is inserted, when the image display apparatus is carried. When the end portion of the supporting member 104 is inserted into the insertion hole 105, the liquid crystal panel 101 is fixed in a status where the liquid crystal panel 101 is rolled around the body 100.

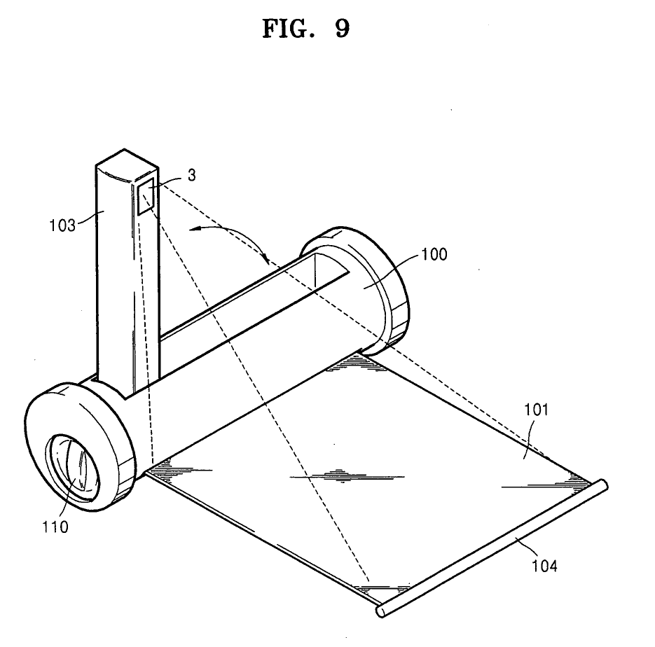

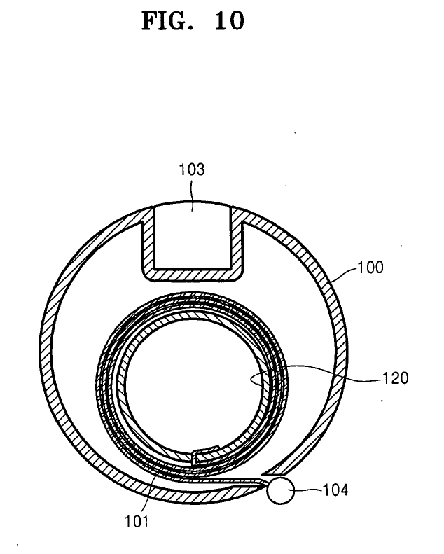

In addition, referring to FIGS. 9 and 10, the reflective liquid crystal panel 101 is formed as a sheet type, and a roller 120 is disposed in the body 100. The roller 120 is connected to a knob 110 that is exposed outside of the body 100. An end of the liquid crystal panel 101 is supported by the roller 120, and the supporting member 104 for supporting the liquid crystal panel 101 to be flat is disposed on the other end of the liquid crystal panel 101. When the image is to be displayed, the reflective liquid crystal panel 101 is spread as shown in FIG. 9 and the arm 103 is raised to irradiate the light onto the reflective liquid crystal panel 101 using the light source unit 3. When the image display apparatus is carried, the arm 103 is folded as shown in FIG. 10 and the knob 110 is turned. Then, the roller 120 rotates and the liquid crystal panel 101 is rolled around an outer circumference of the roller 120. According to the above structure, the liquid crystal panel 101 is received in the body 100 when the image display apparatus is carried, and thus, the damage of the liquid crystal panel 101 can be prevented and the image display apparatus can be carried conveniently.

According to the conventional reflective liquid crystal display apparatus, color filters are installed on a side of the liquid crystal layer in order to display color images. Each of the pixels in the liquid crystal layer is divided into sub-pixels corresponding to red, green, and blue colors. In addition, each of the sub-pixels is controlled independently to control a transmission amount or a diffusion amount of white light irradiated from the light source, and then, the lights passing the sub-pixels are mixed through the color filters to form the color image. In the above conventional flat panel display apparatus, a plurality of sub-pixels are included in each of the pixels, and the sub-pixels should be controlled independently, and thus, the structure of the image display apparatus becomes complex, and it is difficult to realize a color image display apparatus displaying color images of high resolution. In addition, since some of the light irradiated from the light source is used to display the image, a brightness of the image display apparatus is lowered.

However, according to the image display apparatus of an exemplary embodiment of the present invention, the pixels of the reflective liquid crystal panel 101 are controlled in synchronization with the single color lights while irradiating the plurality of single color lights sequentially, and thus, the color filter is not required. In addition, there is no need to divide the pixels into the sub-pixels corresponding to the plurality of single color lights, and thus, the image display apparatus of high resolution can be easily formed. Also, a point light source can be used as the light source unit 3 when the light source irradiates the plurality of single color lights sequentially, therefore a surface light source such as a backlight unit that is optically complicated and expensive is not required.

According to the image display apparatus of an exemplary embodiment of the present invention, the following exemplary effects can be obtained.

Since the light source unit only irradiates the plurality of single color lights sequentially, there is no need to exactly focus on the screen, and the aspect ratio of the irradiated light does not necessarily correspond to the aspect ratio of the displayed image. Thus, the optical system of the image display apparatus of an exemplary embodiment of the present invention is simpler than that of the projector.

In addition, the image can be selectively displayed on the front side or the rear side of the screen using the diffusion mode or the transmission mode of the pixels. Further, the color image can be easily displayed without regard to the shape of the screen, for example, the cylindrical screen.

In addition, if the image is displayed using the diffusion mode of the pixels, the wide viewing angle can be ensured, and thus, the screen can be tilted.

Also, the screen can be maintained entirely in the diffusion mode or in the transmission mode, or the image is displayed on the desired portion of the screen and the other portions of the screen can be in the opaque status or the transparent status by maintaining the diffusion mode or the transmission mode. Therefore, the image display apparatus of an exemplary embodiment of the present invention can be used as a PID effectively.

In addition, since the pixels of the reflective liquid crystal panel are controlled in synchronization with the lights while irradiating the plurality of single color lights, the reflective liquid crystal can display the color image using the simple structure without the color filter. Also, the pixels do not need to be divided into the sub-pixels corresponding to the plurality of single color lights, therefore an image display apparatus of high resolution can be easily manufactured.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image display apparatus comprising:
a screen, wherein a plurality of pixels operating in one of a diffusion mode and a transmission mode are arranged on the screen;
a light source unit which irradiates a plurality of single color lights sequentially onto the screen; and
a driving unit which converts the operating mode of the plurality of pixels into one of the diffusion mode and the transmission mode according to image data, wherein colors of the image data are separated in synchronization with the plurality of single color lights.

2. The image display apparatus of claim 1, wherein the plurality of pixels comprises one of a liquid crystal layer formed of polymer dispersed liquid crystal (PDLC) and a polymer networked liquid crystal (PNLC), and a transparent electrode which applies a voltage to the liquid crystal layer.

3. The image display apparatus of claim 2, wherein the driving unit comprises a gradation driver controlling a magnitude of the voltage applied to the transparent electrode corresponding to a gradation of the image data.

4. The image display apparatus of claim 1, wherein the light source unit is located at an image displaying side of the screen.

5. The image display apparatus of claim 1, wherein the screen comprises one of a flat sheet screen and a cylindrical screen.

6. The image display apparatus of claim 1, wherein said image display apparatus is carriable.

7. An image display apparatus for displaying a color image, the apparatus comprising:
a reflective liquid crystal panel;
a light source unit which irradiates a plurality of single color lights sequentially onto a surface of the reflective liquid crystal panel; and
a driving unit which drives the reflective liquid crystal panel according to image data, wherein colors of the image data are separated in synchronization with the plurality of single color lights.

8. The image display apparatus of claim 7, further comprising:
a body supporting the reflective liquid crystal panel,
wherein the light source unit moves between a first position wherein the light source unit is folded upon the body, and a second position wherein the light source unit is raised for irradiating the plurality of single color lights onto the reflective liquid crystal panel.

9. The image display apparatus of claim 8, wherein a first end portion of the reflective liquid crystal panel is supported by the body, and a second end portion of the reflective liquid crystal panel is exposed outside of the body.

10. The image display apparatus of claim 9, wherein a supporting member which supports the reflective liquid crystal panel to be flat is disposed on the second end portion of the reflective liquid crystal panel.

11. The image display apparatus of claim 10, wherein the body further comprises a fixing unit which fixes the reflective liquid crystal panel to be rolled around the body.

12. The image display apparatus of claim 11, wherein the fixing unit comprises an insertion hole disposed on the body wherein the second end portion of the supporting member can be inserted into the insertion hole.

13. The image display apparatus of claim 9, wherein the body comprises a roller supporting the first end portion of the reflective liquid crystal panel wherein the reflective liquid crystal panel is rolled around an outer circumference of the roller.

14. The image display apparatus of claim 13, wherein a supporting member which supports the reflective liquid crystal panel to be flat is disposed on the second end portion of the reflective liquid crystal panel.

15. The image display apparatus of claim 7, wherein the reflective liquid crystal panel comprises a liquid crystal layer formed of one of a polymer dispersed liquid crystal (PDLC) and a polymer networked liquid crystal (PNLC), and a transparent electrode which applies a voltage to the liquid crystal layer.

16. The image display apparatus of claim 15, wherein the driving unit comprises a gradation driver which controls a magnitude of the voltage applied to the transparent electrode corresponding to the gradation of the image data.
